(19) United States
(12) Patent Application Publication
(10) Pub. No.: US 2023/0274374 A1
(43) Pub. Date: Aug. 31, 2023

(54) PATENT FAMILY CITATION LANDSCAPE TOOL

(71) Applicant: Black Hills IP Holdings, LLC, Minneapolis, MN (US)

(72) Inventor: Steven W. Lundberg, Edina, MN (US)

(21) Appl. No.: 18/108,387

(22) Filed: Feb. 10, 2023

Related U.S. Application Data
(60) Provisional application No. 63/308,868, filed on Feb. 10, 2022.

(51) Int. Cl. G06Q 50/18; G06F 16/9038; G06F 16/907

(52) U.S. Cl. CPC G06Q 50/184; G06F 16/9038; G06F 16/907

(57) ABSTRACT

Various embodiments disclosed relate to a citation landscape tool and method of producing citation landscape analyses. The present disclosure includes methods of receiving a selection of a patent application, identifying patent family members, and aggregating forwards and backwards citations. The landscape tool can be used to produce landscape analyses for user review.

### CLAIM OF PRIORITY

This application claims the benefit of priority under 35 U.S.C. § 119(e) to U.S. Provisional Patent Application Ser. No. 63/308,868, filed on Feb. 10, 2022, each of which is incorporated by reference herein in its entirety.

### BACKGROUND

Patent portfolios can include a variety of patent filings, both foreign and domestic, and can often include several related family members. For example, a given patent portfolio may include an original non-provisional filing, with several divisional and continuation cases claims priority to the original filing. Sometimes, the number of related patents in a given family can become quite large. In each of these filings, patent offices and practitioners often cite to other references, such as other patents and publications, during the process of patent prosecution.

### SUMMARY OF THE DISCLOSURE

The present disclosure provides a program for generating citation landscape analysis of patent families. The program can allow for real time analysis. The program can be used to produce a portfolio of related patent applications and associated backwards citations. The portfolio can be used to notify the user of potential problematic patent applications, such as patents or publications that could potentially cause validity or infringement concerns. The portfolio can be analyzed to produce data on patent uniqueness values and other characteristics; and to analyze and compare claim language.

Often, where a large patent family is present, the patent owner may desire to see how the individual patents are related, and what references, such as patent filings and publications, have been cited during the prosecution history of the family. Being aware of and understanding which references have been cited can affect patent portfolio and claim strategy moving forward. Additionally, such an analysis can help provide an understanding of the patent portfolio uniqueness and overall value.

In an example, an automated method can include receiving a selection of a patent application; identifying, from a database, family members of the patent application; searching for backwards and forwards citations of each of the family members and aggregating the backwards citations; and presenting the citations, on a user interface, for the family members in a citation landscape portfolio for review by a user.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an automated docketing system in a sample embodiment.

FIG. 2 illustrates sample third party data sources that provide docketing data input for an automated docketing system implemented for managing patent portfolios in a sample embodiment.

FIG. 3 is a schematic diagram of a docketing system including a citation landscape tool in an example.

FIGS. 4A-4B are flow charts depicting a method for a citation landscape tool in an example.

FIG. 5 depicts a schematic of a citation landscape tool in an example.

FIGS. 6A-6D depict schematics of citation landscape analyses produced by a citation landscape tool in an example.

FIG. 7 illustrates a block diagram of an example computing machine upon which any one or more of the techniques or methodologies discussed herein may be implemented.

### DETAILED DESCRIPTION

The present disclosure describes, among other things, a citation landscape production method and system for use in a patent analysis study. Discussed herein, such a citation landscape production method can utilize a citation landscape production tool. The citation landscape production tool can be part of a docketing system, or a stand-alone program. The citation landscape production tool can be configured to receive a patent, patent publication, or patent document, and produce a citation landscape analysis for review by a user. Such a citation landscape analysis can, for example, include a list of family members, forward citations, backwards citations, cross-comparison of those citation, among other data and analysis.

As used herein, “electronic communication” refers to an electronic message or a method of exchanging messages between people using electronic devices.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping,” “data scraping,” or “web crawling,” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database,” can refer to a structured set of data, such as held in a computer or on the internet, that can be accessible in various ways.

As used herein, “citation landscape” can refer to a deliverable, such as a document or spreadsheet, indicating citations within a particular patent family. The citations can include forward citations, backwards citations, or both.

As used herein, “portfolio” can refer to a group of patent filings, such as related patents, patent filings of common ownership, patent filings of common inventorship, or other combinations thereof.

As used herein, “patent family” can refer to patent filings that are related, such as parent/child, sibling, or other related patent filings according to the rules of the given patent jurisdiction. In some cases, this can include cases that claims priority to another, cases that are continuations or continuations-in-part, or divisional filings.

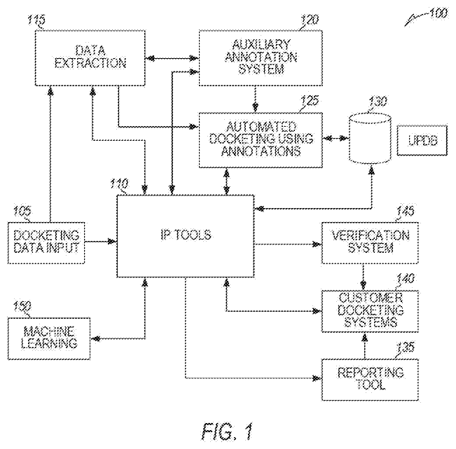

FIG. 1 is a block diagram of a docketing system 100 in an example. The docketing system 100 can be automated or semi-automated. The docketing system 100 can include docketing data input 105, docketing manger 110, data extraction 115, auxiliary annotation system 120, automated docketing using annotations 125, Universal Procedures Database 130, reporting tool 135, customer docketing system 140, verification system 145, and machine learning 150.

The automated docketing system 100 can receive documents from third party sources including third party docketing systems and/or customer data as docketing data input 105. The docketing manger system 110 can process the received documents to provide to the customer docketing systems 140 and prepare the documents for data extraction by the data extraction system 115 as needed.

The data extraction system 115 can perform Optical Character Recognition (OCR) on the received documents from the docketing manger system 110 to extract data, read checkboxes, extract lists, and identify documents where possible. The docketing manger system 110 can also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manger system 110 can receive frequent updates of docketing procedure rules including configuration data and updates the UPDB 130 with universal procedure codes (UPCs) as appropriate. The UPCs can be used in conjunction with customer specific codes, checklists, and templates. The rules can specify how to fill in the templates and how to complete customer-specific procedures such as how to docket documents into the customer's docketing system 140, for example. The template can be filled out by pulling in attributes from the annotations in a document.

The docketing manger system 110 can receive or intake documents and docketing data from several different sources of docketing data input 105, validate the docketing items against entries in a customer's docketing system 140, and communicate those documents to the customer's docketing system 140 via a unified interface. The docketing manger system 110 can also route documents and associated docketing data through the data extraction system 115 and the AAS 120 and organizes the returned metadata and annotations. The docketing manger system 110 thus can provide a breakout between the metadata and the document text.

The docketing manger system 110 can also keep records and communicate with third-party application programming interfaces (APIs) to push the docketing data and documents automatically where allowed. Otherwise, the docketing manger system 110 can present the documents to human docketers to docket. The docketing manger system 110 may also issue reports upon request.

The Docketing manger system 110 can be integrated with a customer's existing docketing system (e.g., Foundation IP), semi-integrated (e.g., CPI, Anaqua, etc.), may provide a virtual host that does not talk at all to the customer's existing docketing system (e.g., Lecopio, IP Manager, Memotech), or may provide outputs in spreadsheet form for use by a docketing administrator to update the customer's docking system 140.

If the Docketing manger system 110 and the customer's docketing system are not integrated, the data output of automated docketing system 100 may be presented to a human docketer for manual entry. For example, the human docketer may implement macros that interface with the customer's docketing system 140 to populate the received data into the customer's docketing system 140.

On the other hand, if the docketing manger system 110 and the customer's docketing system 140 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 130.

The automated docketing system 100 can also perform several post-docketing actions, such as sending docketing reports/details to an external verification system 145 that use a set of rules to verify proper docketing in a host system. The verification system 145 can verifie that the data is correctly added to the external customer's docketing system 140. For example, the verification system 145 can pull data from the AAS 120, the docketing manger system 110, and the customer's docketing system 140 to compare what is present to what is expected to be present in the respective systems.

The automated docketing system 100 may also provide automated email “report out” notifications to customers by implementing a reporting tool 135 that specifies docketing actions based on UPDB template configurations. The reporting tool 135 can also provide completed docketing reports to customers either directly or via the customers' docketing system 140.

In some cases, machine learning techniques may be used to generate annotations. For example, a database of past documents that have been identified may be provided by the docketing manger system 110 and used as a data warehouse to train and improve machine learning models by creating a training set for the machine learning model. Over time, the machine learning model system 150 can learn which PTO IDs to use for which documents, which document in a bundle of documents may be used to characterize the bundle, and may provide predicted PTO IDs for the received documents. The machine learning model system 150 can also establish rule engine prediction capabilities for received documents that test the classifications.

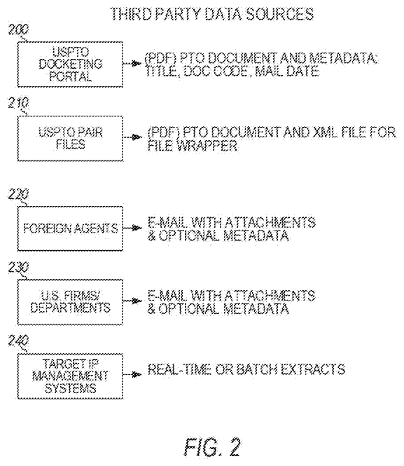

FIG. 2 illustrates sample third party data sources that provide docketing data input 105 for an automated docketing system 100 implemented for managing patent portfolios in an example. As illustrated in FIG. 2, the third party data sources may include the Patent Office (e.g., USPTO) docketing portal 200, which provides documents from the USPTO in portable document format (PDF) and includes metadata identifying the title, document code, and mail date for the corresponding document. The third party data sources may further include USPTO PAIR extensible markup language (XML) files 210, which provide documents from the USPTO in PDF and includes an XML file for patent file wrappers. The third party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third party docketing systems 240 may provide real-time or batch extracts of data for entry into a docketing management system.

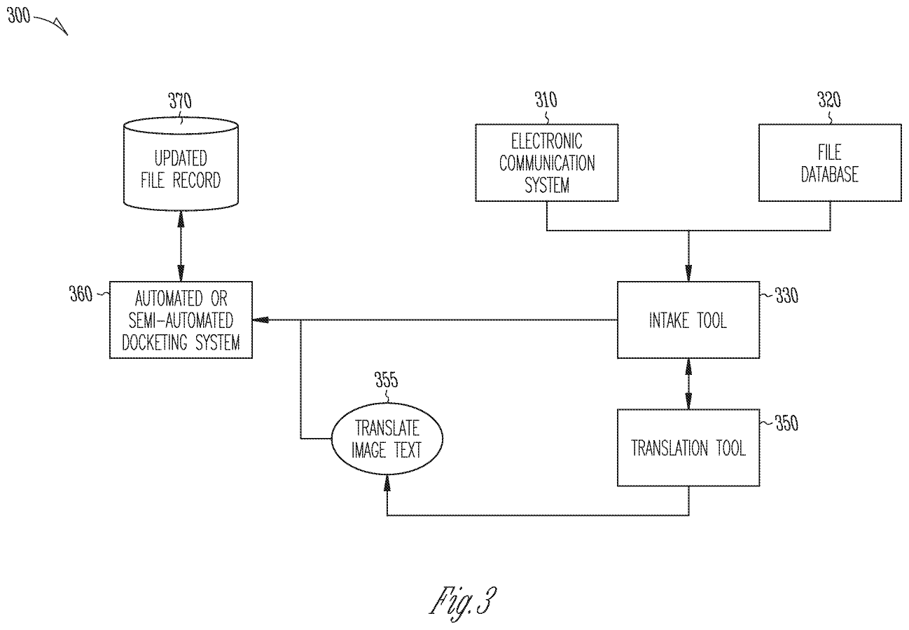

FIG. 3 is a schematic diagram of a file management system 300 in an example. The system 300 can include an electronic communication system 310, a file database 320, an intake tool 330, citation landscape tool 350, a docketing system 360, and a file record 370.

The electronic communication system 310 can be, for example, an e-mail, text, audio, or other means of communicating with internal and external personnel and entities. The electronic communication system 310 can be a user-accessible system for receiving and/or sending messages, such as through a user interface or other computer. The electronic communication system 310 can be, for example, an e-mail server or other communication system.

The file database 320 can include a repository of files or projects being working on by the company. The file database 320 can be, for example, a public or private database, such as a governmental run database. In an example, the USPTO PAIR database can be accessed. In an example, ESPACENET can be accessed. In some cases, other database can be used. In some cases, privately run and updated databases can be accessed. The file database 320 can include information on various files of interest for the business. For example, the file database 320 can include information about patent applications or trademark applications. Such information can, for example, include communications from a governmental agency, responses filed by the company, and other official documents.

The intake tool 330 can include a program or application for receiving electronic communications and associated documents or files. In some cases, the intake tool 330 can be configured to manually or automatically received incoming patent documents or events.

The citation landscape tool 350 can be actuated, for example, to create a patent citation landscape analysis, such as for use in patent preparation or prosecution. The citation landscape tool 350 can receive a patent or patent publication of interest and produce, for use by a user, such as on a user interface, a report of the patent or patent publication landscape. In some cases, the citation landscape tool 350 can be a part of the docketing system 360. In some cases, the citation landscape tool 350 can be a stand-alone tool, such as for use as desired by a person working on a patent or patent publication analysis.

The docketing system 360 can be an automated or semi-automated docketing system, such as the docketing system discussed above with reference to FIG. 1. The docketing system 360 can be in communication with the intake tool 330 and the splitting tool 350, and can receive documents, tasks, and communications with the intake tool 330. The docketing system 360 can communicate with and update the file records 370.

The file records 370 can, for example, be a local or cloud based file storage system including information of files and projects being worked on at or monitored by the company. The file records 370 can contain historical records, such as past events, communications, and decisions in each file.

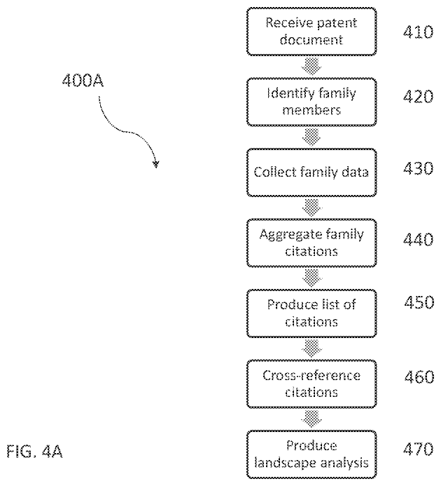

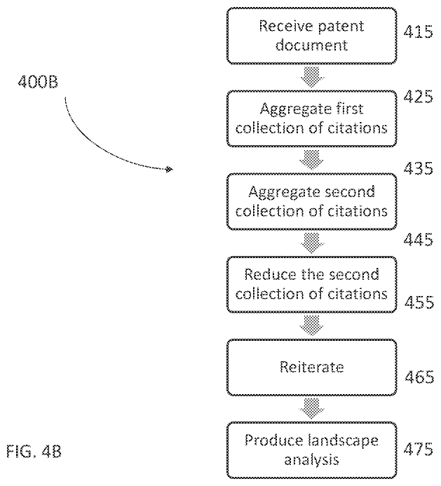

FIG. 4A is a flow chart depicting a method 400 of producing a patent citation landscape with a citation landscape tool, in an example. The method 400 can include blocks 410 to 450.

First, the citation landscape tool can receive a selected patent, patent publication, or patent application (block 410). The citation landscape tool can, for example, receive a patent document from a user, from an electronic communication, or directly from scraping of a database. In some cases, the citation landscape tool can automatically receive a patent document. In some cases, the citation landscape tool can manually receive a patent document from a user.

In some cases, the citation landscape tool can receive one or more documents associated with the selected patent, patent publication, or patent application, and determine from the one or more documents which patent, patent publication, or patent application has been selected. In some cases, the citation landscape tool can automatically receive new documents based on an updated database, or a new electronic communication, which can trigger the citation landscape tool to begin producing a landscape.

Next, the citation landscape tool can identify family members of the selected patent or patent publication (block 420). The citation landscape tool can, for example, identify a serial number or publication number associated with the selected patent. Based on that serial number, the citation landscape tool can interact with and scrape from one or more databases to compile a list of patent family members. In some cases, an application number, publication number, docket number, or other appropriate identification can be used to compile a list of patent family members.

For example, the citation landscape tool can pull data from a governmental database, such as Public PAIR (Patent Application Internet Retrieval) run by the USPTO (U.S. Patent and Trademark Office). In some cases, the citation landscape tool can pull data from a privately run database, such as Google Patents. In some cases, the citation landscape tool can pull data from a collective database, such as ESPACENET. In some cases, the citation landscape tool can receive data from an internal docketing system.

The citation landscape tool can use the identification number of the patent of interest to collect data regarding family members (block 430) such as continuation, divisional, continuation-in-part, and other cases related to the patent of interest, such as according to rules in the patent jurisdiction. The citation landscape tool can additionally identify cases that preceded the pending case, such as parent and sibling cases. The citation landscape tool can identify and select the family members of the patent of interest, and present them to a user on a user interface, such as in a list or spreadsheet.

Next, the citation landscape tool can conduct a citation search (block 440) on each of the family members. The citation landscape tool can, for each identified family member, determine forwards and backwards citations in the case. For example, the citation landscape tool can collect citations for a family member that were made by the patent examiner in the course of prosecution.

Backwards citations can include citations to patents, publications, and other published documents that were made during the prosecution of the patent of interest. Forwards citations can include citations in other patents and publications back to the patent of interest.

The citation landscape tool can then compile a list of the citations (block 450) for each family member, including forward citations, backwards citations, or both. Citations can include, for example, international or national patents, international or national patent publications, academic articles, technical manuals, or other publications which a patent office or patent examiner may cite against a filed patent application.

Subsequently, the citation landscape tool can use the aggregated citations to produce a variety of different analysis documents and/or suggested or automated actions for the pending patent application. For example, the backwards citations can be analyzed and used for production of Information Disclosure Statements (IDS). In some cases, the forward citations can be analyzed and used for determination of the pending patent application's citation in other cases with future priority dates. In some cases, the aggregated citations can be used to produce landscape analyses, such as concept, claim, or ownership landscape productions.

For example, the citation landscape tool can cross-reference (block 460) the provided citations from each family member with those of the others. Cross-reference of citations can include comparing the produced citations for each family member, and highlighting or indicating which citations were cited in only a portion of the family. The cross-reference of citations can be used to execute actions in the context of the patent application, such as production of Information Disclosure Statements (IDS) based on backwards citations.

In this case, if a first pending family member A cited to ten backwards citations, and a second pending family member B cites to only seven of those particular backwards citations, the remaining three backwards citations can be flagged for citation in family member B. In this case, the citation landscape tool can either produce an indication to the user for manual production of IDS, or push an automated IDS production, such that the citations are not missed in the family member B.

In another example, the citation landscape tool can use the aggregated forward citations to produce an analysis for the user. In this case, the citation landscape tool can cross-reference the forward citations of the family members. For example, with family members A, B, and C, the citation landscape tool can aggregate and cross-reference the forward citations. The citation landscape tool can identify, for example, a forward citation Z, which appears with regards to all three family members A, B, and C. The citation landscape tool can flag this particular citation Z to the user for further analysis or for a watch. In some cases, the citation landscape tool can additionally highlight the priority date of the citation Z for comparison to the priority date(s) of the family members A, B, and C.

In another example, the citation landscape tool can aggregate the citations and produce a “mini” landscape analysis. For example, the landscape tool can scrap data from the aggerated citations related to inventors or current owner. In this case, the citation landscape tool can produce a visual chart showing the most common owners or inventors among the citations.

This information can be presented to the user on a user interface (block 470). Such a user interface can be, for example, a monitor, a touch screen, or other display connected to a computer or device capable of running the citation landscape tool. In some cases, the various data from the citation landscape tool can be presented as images, text, spreadsheets, data, charts, document, or in other ways.

FIG. 4B depicts an alternative method 400B of producing a citation landscape analysis with a citation landscape tool, in an example. The method 400B can include blocks 415 to 475.

First, the citation landscape tool can receive a selected patent, patent publication, or patent application (block 415). The citation landscape tool can, for example, receive a patent document from a user, from an electronic communication, or directly from scraping of a database. In some cases, the citation landscape tool can automatically receive a patent document. In some cases, the citation landscape tool can manually receive a patent document from a user.

In some cases, the citation landscape tool can receive one or more documents associated with the selected patent, patent publication, or patent application, and determine from the one or more documents which patent, patent publication, or patent application has been selected. In some cases, the citation landscape tool can automatically receive new documents based on an updated database, or a new electronic communication, which can trigger the citation landscape tool to begin producing a landscape.

Next, the citation landscape tool can conduct a citation search (block 425) on the selected patent. The citation landscape tool can, for the selected patent, determine forwards and backwards citations in the case. For example, the citation landscape tool can collect citations for the selected patent that were made by the patent examiner in the course of prosecution.

These citations can be aggregated into a first collection of citations, and can include forwards citations, backwards citations, or both. Backwards citations can include citations to patents, publications, and other published documents that were made during the prosecution of the patent of interest. Forwards citations can include citations in other patents and publications back to the patent of interest.

At block 435, each of the citations in the first collection of citations can be further analyzed. For example, forwards and/or backwards citations for each of the citations in the first collection can be aggregated. The citation landscape tool can, for the selected citation from the first collection, determine forwards and backwards citations in the case. For example, the citation landscape tool can collect citations for the selected citation from the first collection that were made by the patent examiner in the course of prosecution. These citations can be aggregated into a second collection of citations for further analysis. The list of citations can be expanded to a desired number or amount, such as for example, 500 citations, 400 citations, 300 citations, 200 citation, 100 citations, or another amount.

Then, the citation landscape tool can reduce the second collection of citations to a subset of citations at block 445. The subset can be, for example, selected from the second collection of citations based on a patent relevance determination. For example, the citations that are most relevant can be used to populate the landscape analysis.

The subset, such as with the most relevant citations, can be created by refining the second collection of citations. Refinement can be done, for example, by filtering the citations by CPC or IPC class, by filtering by keywords or concepts, by filtering by dates. In some cases, the refinement can be done by selecting the citations that appear the most frequently in the second collection. In some cases, the refinement can be done by selecting the citations which have the largest keyword overlap with the original selected patent.

The steps of aggregating and refining the citations can be reiterated (block 465) to produce a revised subset of citations based on one or more predetermined parameters, such as a desired number of citations.

Subsequently, the citation landscape tool can use the aggregated and refined citations to produce a variety of different analysis documents and/or suggested or automated actions for the pending patent application. For example, the aggregated and refined citations can be used to produce landscape analyses, such as concept, claim, or ownership landscape productions.

In an example, the citation landscape tool can aggregate the citations and produce a “mini” landscape analysis. For example, the landscape tool can scrap data from the aggerated citations related to inventors or current owner. In this case, the citation landscape tool can produce a visual chart showing the most common owners or inventors among the citations.

This information can be presented to the user on a user interface (block 470). Such a user interface can be, for example, a monitor, a touch screen, or other display connected to a computer or device capable of running the citation landscape tool. In some cases, the various data from the citation landscape tool can be presented as images, text, spreadsheets, data, charts, document, or in other ways.

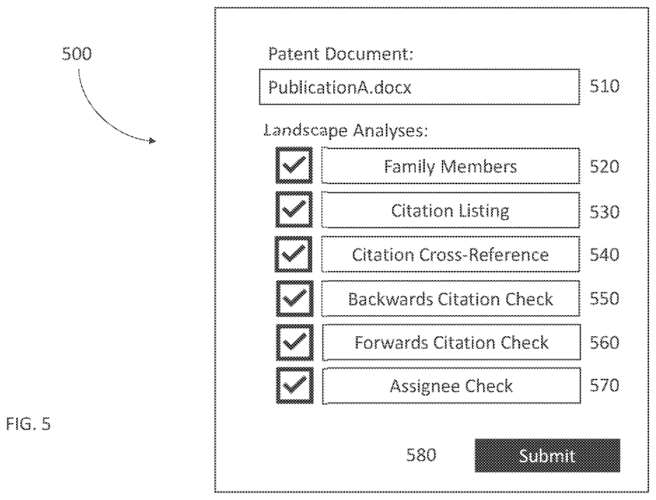

FIG. 5 depicts an example citation landscape tool 500. The landscape tool 500 can have an input field 510, selection menus 520, 530, 540, 550, 560, 570, and submission button 580. The landscape tool 500 can, for example, be used to produce one or more citation landscape analyses, such as described with reference to method 600 above.

The input field 510 can be, for example, a text field, a file search menu, a drop-down menu, or other field for receiving a file. In some cases, the input field 510 can be manually filled by a user desiring a citation landscape study. In this case, the user can fill the field with a document or file, such as a patent document. For example, a patent application, publication, issued patent, an office action, other communication from a patent office, a communication from a foreign agent, or other document that can indicate which patent application case is of interest for the citation landscape.

In some cases, the input field 510 can be automatically filled. In this case, the landscape tool 500 can communication with a patent system, such as an automated or semi-automated patent docketing system. In this case, the patent docketing system can automatically send a new patent document, such as a publication or an office action, to the landscape tool 500 for production of a citation landscape analysis based on the patent application.

In some cases, the landscape tool 500 can be coupled to an official government databased, such as the USPTO PAIR database. In this case, new documents on the PAIR database can be scraped and produced to the landscape tool 500. For example, when a first office action is posted to the PAIR database, the office action can be scraped to the landscape tool 500 and one or more citation landscape analyses can be produced for use in prosecution.

Selection menus 520 to 570 can be used to manually select the type of citation landscape analyses that are desired. In some cases, a user can manually select the desired analyses, such as a list of family members (520), a list of citations (530), a cross-reference analysis of citations (540), a backwards citations check such as for automated IDS (550), a forwards citation check (560), or an assignee landscape (570). Additional or alternative fields can be provided. In some cases, these fields can be pre-selected for automated production of citation landscape analyses. The submission button 550 can be actuated by the user to produce the analyses.

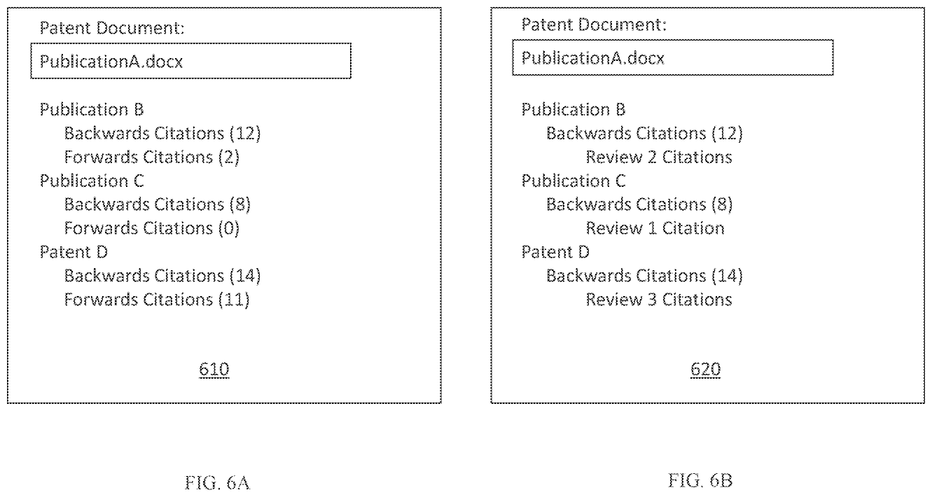

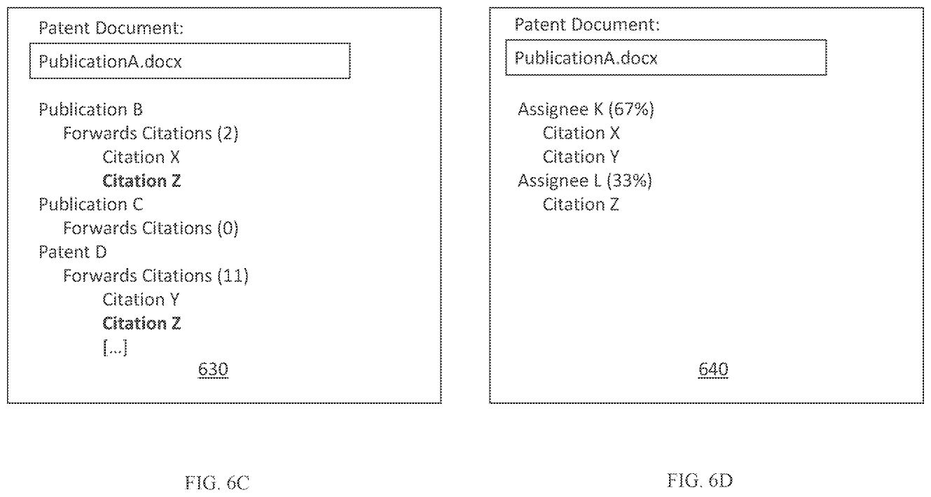

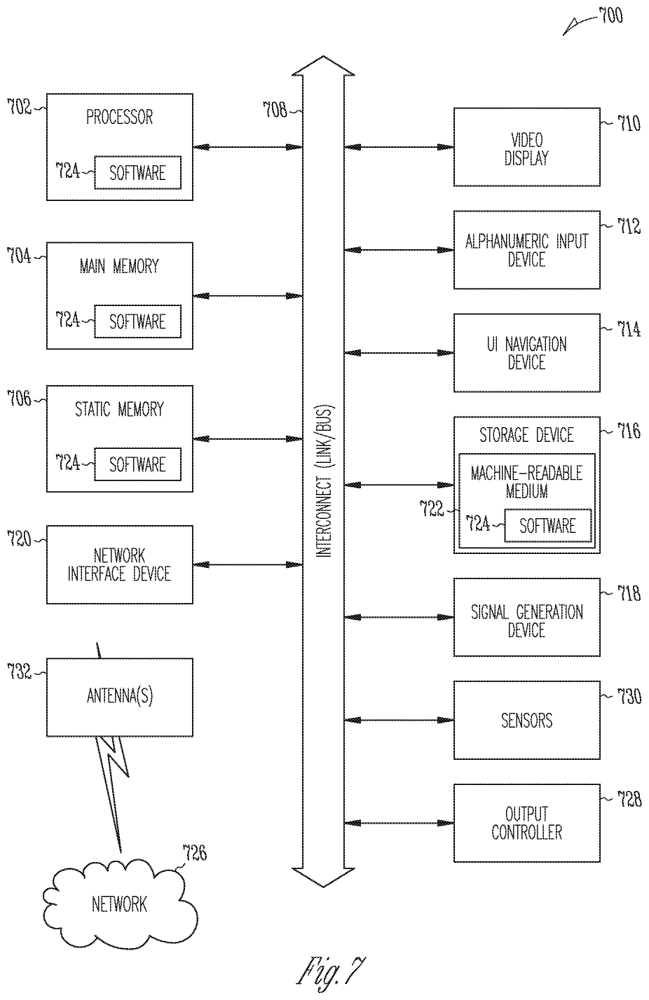

FIGS. 6A-6D depict example citation landscape analyses produced by a citation landscape tool. FIG. 6A depicts a schematic diagram of a citation landscape 610 in an example. In the citation landscape 610, the family members and citations can be listed.

For example, in a patent family can have four members: Publication A, Publication B, Publication C, and Patent D. The citation landscape tool can determine that Publication C has 12 backwards citations and 2 forward citations; Publication D has 8 backwards citations; and issued Patent D has 14 backwards citations and 11 forward citations.

FIG. 6B depicts a schematic diagram of a citation landscape 620 in an example. In the citation landscape 620, the landscape analysis can include a cross-reference of backwards citations. For example, the landscape analysis here provide six backwards citations for review by a user: 2 citations from Publication B, 1 citation from Publication C, and 3 citations from Patent D. These citations can be flagged for citation in the pending family member Publication A. In this case, the citation landscape tool can either produce an indication to the user for manual production of IDS, or push an automated IDS production, such that the citations are not missed in the Publication A.

FIG. 6C depicts a schematic diagram of a citation landscape 630 in an example. In citation landscape 630, forwards citations are highlighted from each of the family members. Here, the citation landscape tool can use the aggregated forward citations to produce an analysis for the user. In this case, the citation landscape tool can cross-reference the forward citations of the family members. The citation landscape tool can identify, for example, a forward citation Z, which appears with regards to two family members, Publication B and Patent D. The citation landscape tool can flag this particular citation Z to the user for further analysis or for a watch. In some cases, the citation landscape tool can additionally highlight the priority date of the citation Z for comparison to the priority date(s) of the family members.

FIG. 6D depicts a schematic diagram of a citation landscape 640 in an example. In the landscape 640, Here, the citation landscape tool can aggregate the citations and produce a “mini” landscape analysis. For example, the landscape tool can scrap data from the aggerated citations related to inventors or current owner. Shown in FIG. 6D, the breakdown of assignees for particular citations is shown. In some cases, a pie chart or other visual representation can also be produced.

In some cases, a citation landscape can include additional analysis. For example, the landscape can include reviewing and analyzing each of the citations that are produced. In this case, for example, the claims of the citations can be analyzed. In some cases, the claim language can be broken down into one or more concepts, such as subject matter, system parts, or other subject matter.

Once concepts are determined, the claims of all citations of interest can be analyzed for these concepts. For example, this can be done by keyword matching or other search techniques. This breakdown can be presented to a user, such as in a chart. The chart can include, for example, the one or more concepts, the claim language, and instances of use of each of the one or more concepts in the claim language. In some cases, a graphical representation of the landscape can be included.

In some cases, analyzing the landscape can include producing a uniqueness value. Such a uniqueness value can be produced by reviewing claim language of each of the citations, comparing the claim language to the other of the citations, assigning a score to each of the citations based on the comparison of claim language, wherein the score is relatively higher where less language is overlapping between each of the citations.

In some cases, analyzing the citation landscape portfolio can include producing a risk of infringement analysis value. Such a risk of infringement analysis value can be produced by analyzing claim language from the selected patent for one or more concepts, selecting one of the citations for comparison, analyzing claim language from the selection citation for the one or more concepts, determining each of the one or more concepts that appear in both the selected patent and the selected citation, and recommending review of any of the one or more concepts that appear in both the selected patent and the selected citation, if the one or more concepts appears above a threshold level. In some cases, each of the one or more citations that appears above the threshold level can be flagged.

FIG. 7 illustrates a block diagram of an example computing system machine 700 upon which any one or more of the techniques (e.g., methodologies) discussed herein may perform. Machine 700 (e.g., computer system) may include a hardware processor 702 (e.g., a central processing unit (CPU), a graphics processing unit (GPU), a hardware processor core, or any combination thereof), a main memory 704 and a static memory 706, connected via an interconnect 708 (e.g., link or bus), as some or all of these components may constitute hardware for systems 100 or 200 or hardware to operate the services and subsystems and related implementations discussed above.

Specific examples of main memory 704 include Random Access Memory (RAM), and semiconductor memory devices, which may include, in some embodiments, storage locations in semiconductors such as registers. Specific examples of static memory 706 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 700 may further include a display device 710, an input device 712 (e.g., a keyboard), and a user interface (UI) navigation device 714 (e.g., a mouse). In an example, the display device 710, input device 712 and UI navigation device 714 may be a touch screen display. The machine 700 may additionally include a mass storage device 716 (e.g., drive unit), a signal generation device 718 (e.g., a speaker), a network interface device 720, and one or more sensors 730, such as a global positioning system (GPS) sensor, compass, accelerometer, or some other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the hardware processor 702 and/or instructions 724 may comprise processing circuitry and/or transceiver circuitry.

The mass storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage device 716 constitutes, in at least some embodiments, machine readable media.

The term “machine readable medium” includes, in some embodiments, any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Specific examples of machine readable media include, one or more of non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks. While the machine readable medium 722 is illustrated as a single medium, the term “machine readable medium” includes, in at least some embodiments, a single medium or multiple media (e.g., a centralized or distributed database, and/or associated caches and servers) configured to store the one or more instructions 724. In some examples, machine readable media includes non-transitory machine readable media. In some examples, machine readable media includes machine readable media that is not a transitory propagating signal.

The instructions 724 are further transmitted or received, in at least some embodiments, over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

An apparatus of the machine 700 includes, in at least some embodiments, one or more of a hardware processor 702 (e.g., a central processing unit (CPU), a graphics processing unit (GPU), a hardware processor core, or any combination thereof), a main memory 704 and a static memory 706, sensors 730, network interface device 720, antennas 732, a display device 710, an input device 712, a UI navigation device 714, a mass storage device 716, instructions 724, a signal generation device 718, and an output controller 728. The apparatus is configured, in at least some embodiments, to perform one or more of the methods and/or operations disclosed herein. The apparatus is, in some examples, a component of the machine 700 to perform one or more of the methods and/or operations disclosed herein, and/or to perform a portion of one or more of the methods and/or operations disclosed herein.

In an example embodiment, the network interface device 720 includes one or more physical jacks (e.g., Ethernet, coaxial, or phone jacks) or one or more antennas to connect to the communications network 726. In an example embodiment, the network interface device 720 includes one or more antennas 732 to wirelessly communicate using at least one of single-input multiple-output (SIMO), multiple-input multiple-output (MIMO), or multiple-input single-output (MISO) techniques. In some examples, the network interface device 720 wirelessly communicates using Multiple User MIMO techniques. The term “transmission medium” shall be taken to include any intangible medium that is capable of storing, encoding or carrying instructions for execution by the machine 700, and includes digital or analog communications signals or other intangible medium to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as but not limited to source code, compiled code, interpreted code, executable code, static code, dynamic code, and the like. Such a computer-readable medium includes any tangible non-transitory medium for storing information in a form readable by one or more computers, such as but not limited to read only memory (ROM); random access memory (RAM); magnetic disk storage media; optical storage media; flash memory, etc.

Various embodiments may be implemented fully or partially in software and/or firmware. This software and/or firmware may take the form of instructions contained in or on a non-transitory computer-readable storage medium. Those instructions are then read and executed by one or more processors to enable performance of the operations described herein. The instructions are in any suitable form, such as but not limited to source code, compiled code, interpreted code, executable code, static code, dynamic code, and the like. Such a computer-readable medium includes, in at least some embodiments, any tangible non-transitory medium for storing information in a form readable by one or more computers, such as but not limited to read only memory (ROM); random access memory (RAM); magnetic disk storage media; optical storage media; flash memory, etc.

### VARIOUS NOTES & EXAMPLES

Example 1 is an automated method comprising: receiving a selection of a patent application; identifying, from a database, family members of the patent application; searching for backwards and forwards citations of each of the family members and aggregating the backwards citations; and presenting the citations, on a user interface, for the family members in a citation landscape portfolio for review by a user.

In Example 2, the subject matter of Example 1 optionally includes wherein receiving a selection of a patent application comprises receiving an electronic communication discussing the patent application.

In Example 3, the subject matter of any one or more of Examples 1-2 optionally include wherein receiving a selection of a patent application comprises scraping a new event on a database related to the patent application.

In Example 4, the subject matter of any one or more of Examples 1-3 optionally include wherein receiving a selection of a patent application comprises identifying a patent application of interest in a received document.

In Example 5, the subject matter of any one or more of Examples 1-4 optionally include wherein the citations comprise at least one patent or patent publication, each of the citations comprising at least one Example.

In Example 6, the subject matter of any one or more of Examples 1-5 optionally include analyzing the citation landscape portfolio.

In Example 7, the subject matter of Example 6 optionally includes wherein analyzing the citation landscape portfolio comprises: reviewing the at least one Example in each of the citations to determine claim language; breaking the claim language into one or more concepts; determining how often each of the concepts appears in the claim language in each of the citations; and presenting, on a user interface, a chart depicting the analysis of claim language for review by a user, wherein the chart shows the one or more concepts, the claim language, and instances of use of each of the one or more concepts in the claim language.

In Example 8, the subject matter of Example 7 optionally includes producing a graphical representation of the chart.

In Example 9, the subject matter of any one or more of Examples 6-8 optionally include wherein analyzing the citation landscape portfolio comprises: reviewing the at least one Example in each of the citations to determine claim language; breaking the claim language into one or more phrases; determining how often each of the phrases appears in the claim language in each of the citations; and presenting, on a user interface, a chart depicting the analysis of claim language for review by a user, wherein the chart shows the one or more phrases, the claim language, and instances of use of each of the one or more concepts in the claim language.

In Example 10, the subject matter of Example 9 optionally includes producing a graphical representation of the chart.

In Example 11, the subject matter of any one or more of Examples 6-10 optionally include wherein analyzing the citation landscape portfolio comprises producing a uniqueness value.

In Example 12, the subject matter of Example 11 optionally includes wherein producing a uniqueness value comprises: reviewing Example language of each of the citations; comparing the claim language to the other of the citations; assigning a score to each of the citations based on the comparison of claim language, wherein the score is relatively higher where less language is overlapping between each of the citations.

In Example 13, the subject matter of any one or more of Examples 6-12 optionally include wherein analyzing the citation landscape portfolio comprises producing a risk of infringement analysis value.

In Example 14, the subject matter of Example 13 optionally includes wherein producing a risk of infringement analysis value comprises: analyzing Example language from the selected patent for one or more concepts; selecting one of the citations for comparison; analyzing claim language from the selection citation for the one or more concepts; determining each of the one or more concepts that appear in both the selected patent and the selected citation; and recommending review of any of the one or more concepts that appear in both the selected patent and the selected citation, if the one or more concepts appears above a threshold level.

In Example 15, the subject matter of any one or more of Examples 12-14 optionally include flagging each of the one or more citations that appears above the threshold level.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An automated method comprising:
receiving a selection of a patent application;
aggregating a first collection of citations of the selected patent application, wherein the first collection of citations comprise backwards citations, forwards citations, or both of the selected patent application;
aggregating a second collection of citations based on the first collection of citations, wherein the second collection of citations comprise backwards citations, forwards citations, or both of the first collection of citations;
reducing the second collection of citations to a subset of citations, wherein the subset is selected from the second collection of citations based on a patent relevance determination;
reiterating aggregation and reduction to produce a revised subset of citations based on one or more predetermined parameters;
producing a landscape based on the revised subset of citations; and
presenting the landscape on a user interface for a user.

2. The method of claim 1, further comprising:
identifying, from a database, family members of the patent application, wherein aggregating the first collection of citations comprises aggregating citations of each of the family members, wherein the citations comprise backwards citations, forwards citations, or both of each of the family members.

3. The method of claim 1, wherein receiving a selection of a patent application comprises receiving an electronic communication discussing the patent application.

4. The method of claim 1, wherein receiving a selection of a patent application comprises scraping a new event on a database related to the patent application.

5. The method of claim 1, wherein receiving a selection of a patent application comprises identifying a patent application of interest in a received document.

6. The method of claim 1, wherein the citations comprise at least one patent or patent publication, each of the citations comprising at least one claim.

7. The method of claim 1, further comprising analyzing the landscape.

8. The method of claim 7, wherein analyzing the landscape comprises:
reviewing the at least one claim in each of the citations to determine claim language;
breaking the claim language into one or more concepts;
determining how often each of the concepts appears in the claim language in each of the citations; and
presenting, on a user interface, a chart depicting the analysis of claim language for review by a user, wherein the chart shows the one or more concepts, the claim language, and instances of use of each of the one or more concepts in the claim language.

9. The method of claim 7, further comprising producing a graphical representation of the landscape.

10. The method of claim 7, wherein analyzing the landscape comprises:
reviewing the at least one claim in each of the citations to determine claim language;
breaking the claim language into one or more phrases;
determining how often each of the phrases appears in the claim language in each of the citations; and
presenting, on a user interface, a chart depicting the analysis of claim language for review by a user, wherein the chart shows the one or more phrases, the claim language, and instances of use of each of the one or more concepts in the claim language.

11. The method of claim 10, further comprising producing a graphical representation of the chart.

12. The method of claim 7, wherein analyzing the landscape comprises producing a uniqueness value.

13. The method of claim 12, wherein producing a uniqueness value comprises:
reviewing claim language of each of the citations;
comparing the claim language to the other of the citations;
assigning a score to each of the citations based on the comparison of claim language, wherein the score is relatively higher where less language is overlapping between each of the citations.

14. The method of claim 7, wherein analyzing the citation landscape portfolio comprises producing a risk of infringement analysis value.

15. The method of claim 14, wherein producing a risk of infringement analysis value comprises:
analyzing claim language from the selected patent for one or more concepts;
selecting one of the citations for comparison;
analyzing claim language from the selection citation for the one or more concepts;
determining each of the one or more concepts that appear in both the selected patent and the selected citation; and
recommending review of any of the one or more concepts that appear in both the selected patent and the selected citation, if the one or more concepts appears above a threshold level.

16. The method of claim 13, further comprising flagging each of the one or more citations that appears above the threshold level.

17. The method of claim 1, wherein reducing the second collection of citations to a subset of citations comprises filtering the citations by class.

18. The method of claim 1, wherein reducing the second collection of citations to a subset of citations comprises filtering the citations by keyword.

19. The method of claim 1, wherein reducing the second collection of citations to a subset of citations comprises filtering the citations by concept.

20. The method of claim 1, wherein reducing the second collection of citations to a subset of citations comprises filtering the citations by assignee.

21. The method of claim 1, wherein reducing the second collection of citations to a subset of citations comprises filtering the citations by date.

22. The method of claim 1, wherein reducing the second collection of citations to a subset of citations comprises filtering the citations by frequency.
